(19) United States
(12) Patent Application Publication
(10) Pub. No.: US 2013/0080208 A1
(43) Pub. Date: Mar. 28, 2013

(54) User-Centric Opinion Analysis for Customer Relationship Management

(71) Applicants: Jun WANG, San Jose, CA (US); Kanji UCHINO, San Jose, CA (US)

(72) Inventors: Jun WANG, San Jose, CA (US); Kanji UCHINO, San Jose, CA (US)

(73) Assignee: Fujitsu Limited, Kanagawa (JP)

(21) Appl. No.: 13/242,352

(22) Filed: Sep. 23, 2011

(51) Int. Cl. G06Q 30/02; G06Q 10/10

(52) U.S. Cl. 705/7.32

(57) ABSTRACT

In one embodiment, for each of one or more users, the user having provided one or more opinions concerning one or more products, deriving one or more opinion records from the one or more opinions, wherein each opinion record is derived from a specific opinion provided by the user concerning a specific product; generating a user-preference profile based on the one or more opinion records, wherein: the user-preference profile comprises one or more user-preference vectors corresponding to the one or more products; and each user-preference vector comprises one or more features of the corresponding product and one or more feature scores respectively corresponding to the one or more features.

### TECHNICAL FIELD

This disclosure generally relates to user or customer opinion analysis.

### BACKGROUND

Developers, manufacturers, retailers, and marketers often collect opinions or feedbacks concerning their products or services from their users or customers. These opinions or feedbacks may be collected from various sources, both online and offline. Sometimes, a user or customer may be asked to rate a product or service as a whole (e.g., using a predefined rating scale), or rate different attributes, features, or aspects of a product or service. Sometimes, a user or customer may be given the opportunity to comment on a product or service (e.g., as free-form text). The opinions or feedbacks collected from the users or customers may be analyzed for various purposes, such as improving design or functionalities of existing products or services, developing new products or services, product or service selection, and targeted marketing.

### BRIEF DESCRIPTION OF THE DRAWINGS

FIG. 1 illustrates an example system for user-centric opinion analysis and customer relationship management.

FIG. 2 illustrates an example method for extracting opinion records from texts containing user opinions.

FIG. 3 illustrates an example method for generating product-preference profiles for individual users.

FIG. 4 illustrates an example method for refining product attributes based on user influence.

FIG. 5 illustrates an example method for targeting customer relationship management.

FIG. 6 illustrates an example computer system.

FIG. 7 illustrates an example network environment.

FIG. 8 illustrates an example dependency template.

### DESCRIPTION OF EXAMPLE EMBODIMENTS

Opinions or feedbacks concerning products or services collected from users or customers are often analyzed for various purposes, such as improving design or functionalities of existing products or services, developing new products or services, product or service selection, and targeted marketing. However, existing user opinion analysis systems mostly focus on the products or services for which the opinions are provided and collected. Such systems may be referred to as “product-centric” opinion analysis systems. On the other hand, this disclosure illustrates a “user-centric” opinion analysis system, which focuses on the products or services for which the opinions are collected as well as the users providing these opinions. In other words, the user-centric opinion analysis system not only considers the opinions expressed about the products or services but also who (e.g., the users or customers) have expressed those opinions.

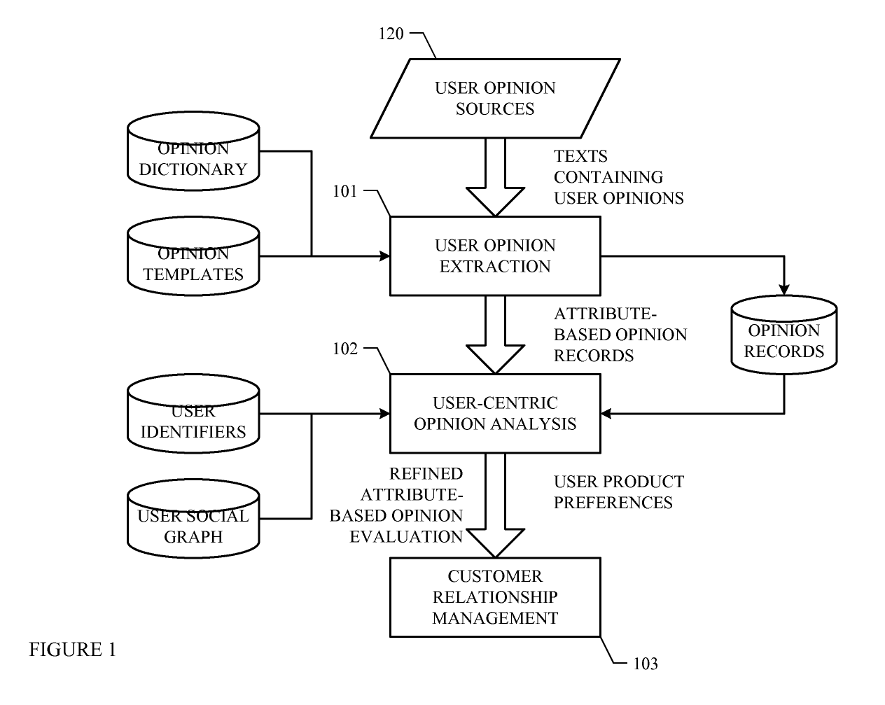

FIG. 1 illustrates an example system for user-centric opinion analysis and customer relationship management. In particular embodiments, texts containing user opinions or opinion expressions concerning products or services are collected from various sources (120), either offline or online or both. Texts containing user opinions may be collected from any number of sources (120), and this disclosure contemplates any applicable opinion source (120). For example, texts containing user opinions or opinion expressions may be collected from product surveys, social-networking websites (e.g., Twitter or Facebook), or e-commerce websites (e.g., Amazon or Netflix). A product may be a physical product or a software product. The texts containing user opinions are processed, and attribute-based opinion records are extracted from these opinions (STEP 101). Each opinion record takes into consideration, among others, the user who has provided the opinion from which the opinion record is extracted. Product preferences are generated for the users based on the opinion records (STEP 102). In addition, the attributes are evaluated and refined (STEP 102), taking into consideration the users providing the opinions and their influences on others (e.g., other users). In particular embodiments, targeted marketing may be conducted based on the users' product preferences and the refined attribute-based opinion evaluation (STEP 103) of products.

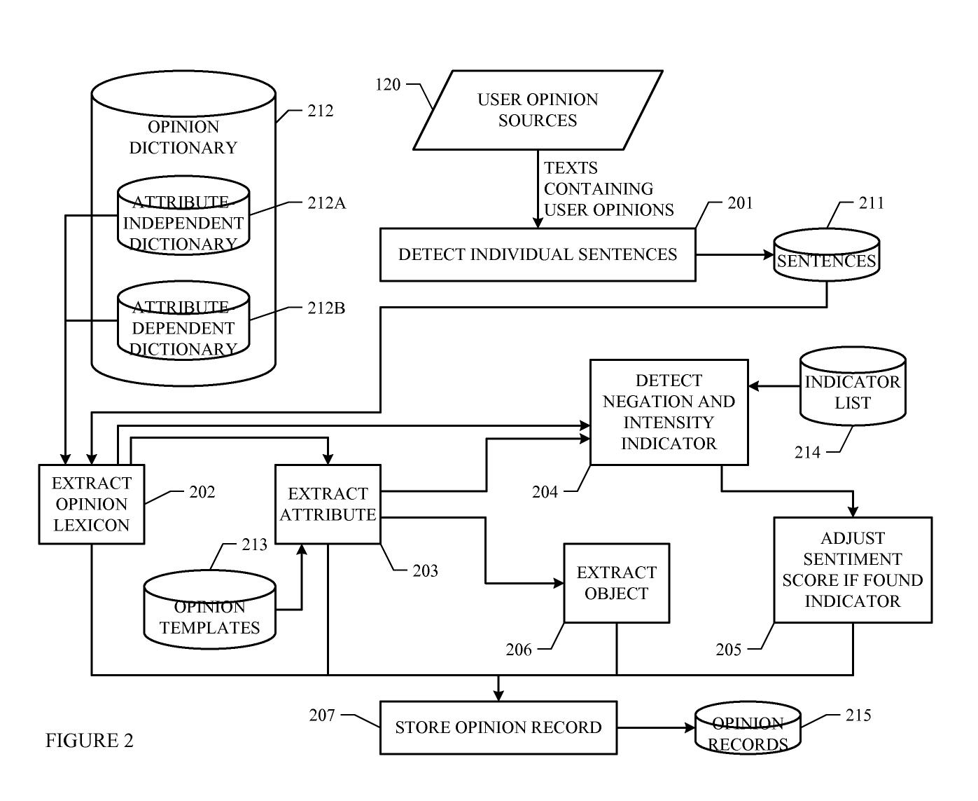

FIG. 2 illustrates an example method for extracting opinion records from texts containing user opinions or opinion expressions concerning products or services. In particular embodiments, texts containing user opinions concerning specific products or services may be collected from various opinion sources (120), either online or offline or both. Each user opinion text may be in free-form and including any number of sentences. The steps illustrated in FIG. 2 may be similarly applied to each available user opinion text.

Given a specific input text containing user opinions, the individual sentences included in the opinion may be detected (STEP 201) based on, for example, applicable language grammar. For example, with many languages, a space (“ ”) usually separates two words. A dash (“-”) sometimes links two words to form a compound word. A period (“.”) often indicates the end of a sentence, and the word immediately after the period is likely the beginning of another sentence. By parsing the opinion text based on the applicable language grammar, the opinion text may be separated into a number of individual sentences.

In particular embodiments, some of the sentences detected in the texts containing user opinion may be manually annotated. These annotated sentences may be used as training data to train a computer to learn to extract user opinions. Machine learning is a scientific discipline that is concerned with the design and development of algorithms that allow computers to learn based on data. The desired goal is to improve the algorithms through experience (e.g., by applying the data to the algorithms in order to “train” the algorithms). The data are thus often referred to as “training data”. The machine learning process trains computers to learn to perform certain functionalities. Typically, an algorithm is designed and trained by applying training data to the algorithm. The algorithm is adjusted (i.e., improved) based on how it responds to the training data. Often, multiple sets of training data may be applied to the same algorithm so that the algorithm may be repeatedly improved.

In order to train a computer to extract user opinions, the training data (e.g., user opinions) are manually annotated. It may be computationally intensive for large scale document processing. To manually prepare the training data, a reasonably sufficient number of user opinions may be prepared. Each sentence in these texts containing user opinions is manually checked and marked (e.g., object, feature, sentiment expression, score, etc.). These annotated training data are input to a machine learning system to generate automatic sentiment analysis rules.

In some implementations, FIG. 2 may be implemented as computer software, which may be executed on computing devices. The texts containing user opinions may be processed and analyzed and the attribute-based opinion records may be extracted automatically.

In particular embodiments, the sentences detected from the input text containing the user opinion may be stored (e.g., in datastore 211) for further analysis. For example, for each input text, the individual sentences detected in the input text may be stored together as an ordered list, such that the first entry of the list is the first sentence found in the input text, the second entry of the list is the second sentence found in the input text, and so on. A number of attribute-based opinion records may be determined for the input text containing the user opinion by analyzing the individual sentences included in the user opinion.

In particular embodiments, each attribute-based opinion record may have a predefined format. In some implementations, each attribute-based opinion record has the following format: (@User, Object, Attribute, OpinionExpression, OpinionScore, Time). For this opinion-record format, “User” is the user (e.g., indicated by the user's identifier (ID)) providing the opinion; “Object” is the product or service for which the opinion is given; “Attribute” is a specific attribute or feature of the product or service for which the opinion is given; “OpinionExpression” is an expression describing the “Feature”; “OpinionScore” is a score rating the “Attribute” (e.g., a number in a predefined range); and “Time” is the time when the opinion is given. In this disclosure, the terms “feature” and “attribute” are used interchangeably.

An example opinion record in this format may be: (@user_{—}1, Audi, engine, powerful, +4.5, 5:00 pm 3/1/2011). In this case, the user ID of the user providing the opinion is “user_{—}1”. The product for which the opinion is given is an “Audi” automobile. The specific attribute of the product for which the opinion is given is the “engine” of the automobile. The user describes the engine as “powerful”. The score determined for the engine feature is “+4.5”. The time when the opinion is given is “5:00 pm 3/1/2011” (Mar. 1, 2011, 5:00 pm).

Such opinion records are referred to as “attribute-based” opinion records because each record is concerned with a specific feature or attribute of a product or service. When a user provides an opinion or feedback for a product or service, the user may express his/her views on any number of features or attributes of that product or service. For example, for an Audi automobile, the user may express his/her views on its engine, exterior design, interior design, gas mileage, electronic components, etc. Each feature discussed in the user opinion may have a corresponding attribute-based opinion record. Thus, multiple opinion records may be determined based on an input user opinion text. For example, another opinion record for the Audi automobile, also determined from the user opinion text provided by “user_{—}1”, may be: (@user_{—}1, Audi, mileage, average, +1.2, 5:00 pm 3/1/2011). In this case, the user describes the gas mileage of the Audi automobile as “average”, and the score determined for the mileage feature is “+1.2”.

When a user provides an opinion or feedback text concerning a product or service, the user is often required to log into his/her account or give his/her name. Thus, the ID or name of the user providing each opinion may be collected at the time when the user submits his/her opinion. Similarly, the time when the user submits his/her opinion may also be collected. For example, upon submission, each user opinion may be associated with a user ID of the user providing the opinion and a timestamp indicating the time of the submission.

In particular embodiments, the individual sentences of a user opinion may be analyzed to extract additional information, such as Object, Attribute, OpinionExpression, and OpinionScore, needed for constructing attribute-based opinion records for the user opinion in a specific format. Given a specific sentence found in a specific user opinion text, the sentence may be parsed and analyzed, and an attempt is made to extract opinion lexicon (STEP 202), feature or attribute (STEP 203), negation and intensity indicator (STEP 204), and object (STEP 206) from the sentence. Not every sentence may include each and every one of these types of information, and some sentences may provide some types of information while other sentences may provide other types of information. The information extracted from all the sentences found in a specific user opinion may be combined to construct opinion records for the user opinion.

In particular embodiments, opinion lexicon may be a predefined set of words or expressions, which may be applicable and used to describe features or attributes of products or services. For example, they are words that users may use to express their views when providing opinions or feedbacks concerning various products or services. These words may form an opinion dictionary (212). In some implementations, the words may be further categorized into an attribute-independent dictionary (212A) and an attribute-dependent dictionary (212B). These dictionaries (212A and 212B) may contain attribute words as well as corresponding opinion expression words, and may be stored so that they are readily accessible. In some implementations, the opinion lexicon may be words (e.g., adjectives, adverbs, nouns, verbs, etc.) that describe or express users' opinions on products or services (e.g., “powerful”, “good”, “bad”, “terrible”, “efficiently”, “beauty”, “junk”, “hate”, “like”, etc.). Some words may be applicable only to specific features or attributes (i.e., attribute-dependent words), while other words may be generally applicable (i.e., attribute-independent words). The individual words in each sentence may be matched to attribute-independent dictionary (212A) and attribute-dependent dictionary (212B), and words included in either dictionary are extracted from each sentence.

In particular embodiments, a feature or attribute may be a specific aspect or characteristic of a product or service. Different products or services may have different types of features or attributes. For example, the features of an automobile may include its engine, gas mileage, exterior design, interior design, transmission, etc. On the other hand, the features of a digital camera may include pixel resolution, image format, aperture, shutter speed, lens, etc. In some implementations, there may be a predefined set of opinion templates (213), and the attributes are extracted from the individual sentences based on these opinion templates (213). Each sentence may be compared against opinion templates (213). If the sentence aligns with an opinion template (213) containing attribute words, an explicit attribute may be extracted from the sentence based on that opinion template (213). In some other template matches, if no explicit attribute is found in the sentence, an implicit attribute may be specified based on the opinion lexicon, if any, found in the sentence.

In some implementations, each opinion template (213) may include a specific attribute, an expression (i.e., OpinionExpression) that may be used to describe that attribute, and a score (i.e., OpinionScore) for that expression. Expressions may be, for example, adjectives, adverbs, nouns, verbs, phrases, etc. Different attributes may have different associated expressions. For example, an engine of an automobile may be described as “powerful”, “strong”, “reliable”, “weak”, “mediocre”, etc., while the interior of an automobile may be described as “sleek”, “classical”, “comfortable”, “roomy”, etc. Different expressions may be associated with different scores. For example, a positive expression may be associated with a positive score, and a negative expression may be associated with a negative score. The stronger the expression, the higher or lower the score. The following is an example of the opinion dictionary (212), also referred to as the opinion lexicon dictionary. A concrete attribute or feature can be grouped into a pre-defined attribute or feature category.

| ATTRIBUTE | | OPINION | |
|---|---|---|---|
| CATEGORY | ATTRIBUTE | EXPRESSION | SCORE |
| driving performance | engine | powerful | +4 |
| driving performance | engine | quiet | +4 |
| equipment | Bluetooth | excellent | +5 |
| driving performance | (speed) | fast | +3 |
| fuel efficiency | fuel efficiency | terrible | −5 |
| quality | manufacturing | outstanding | +5 |
| | quality | | |
| price | (price) | expensive | |

### Example Opinion Lexicon Dictionary

Each sentence with opinion expressions may be compared with individual opinion templates (213) to determine whether the sentence may match a specific template.

In particular embodiments, given a specific sentence, first, the sentence is checked to determine whether it contains any opinion expression. Since not all sentences necessarily contain opinion expressions, those sentences that do not contain any opinion expression are filtered out. The opinion expressions may be defined in opinion dictionary 212. Thus, the sentence may be checked based on opinion dictionary 212.

Suppose that the sentence does contain one or more opinion expressions. Next, an attempt is made to extract attribute from the sentence using opinion templates 213. The sentence may be matched to opinion templates 213. If a match is found, then the attribute may be extracted from the sentence based on the matching template. If an explicit attribute is found, an attribute-based user record may be constructed using the explicit attribute. On the other hand, if no explicit attribute is found, an implicit attribute may be specified for the sentence based on opinion dictionary. An attribute-based opinion record may then be constructed using the implicit attribute. This record may include an attribute, an expression describing the attribute, and a score corresponding to the expression. For example, a template for matching sentences with implicit attributes may be $sentence=˜/\b($object)\s($mod0)\s(($not)\s)?(($intensity)\s)?($OpinionExp)\b/. This template may be matched to the sentence, “Audi A8 is really stylish!”, as the following: (1) $object applies to “Audio A8” as Object; (2) $mod0 applies to “is”; (3) $intensity applies to “really” as intensity indicator; and (4) $OpinionExp applies to “stylish” as opinion expression.

If the sentence contains an object, that object may also be extracted from the sentence. If the sentence does not contain an object, previous sentences (i.e., sentences before this current sentence) may be scanned for an object. In some implementations, a list of product names may be predefined as objects, based on customers' interests or requirements.

Finally, the sentence is further analyzed to determine whether it contains any negation and/or intensity indicator, based on indicator list 214. If so, the score of the opinion record is adjusted accordingly. For example, if a negation indicator is found, the current score may be negated. If an intensity indicator is found, the current score may be further increased or decreased accordingly.

To further explain explicit and implicit attributes, consider the following examples. From the sentence “The engine of Audi A8 is so powerful”, the term “engine” is an explicit feature or attribute. From the sentence “The car is beautiful”, the term “appearance” is an implicit attribute. From the sentence “The manufacturing quality of Toyota is outstanding”, the term “manufacturing quality” is an explicit attribute. From the sentence “The BMW is too expensive”, the term “price” is an implicit attribute. These explicit and implicit attributes are defined in the opinion lexicon dictionary.

Sometimes, within a sentence, specific words may have inter-dependency relationships between them. For example, an adjective usually describes a noun, while an adverb usually describes a verb. Consider the following example sentence: “ScanSnap is very fast but most importantly, the software works efficiently.” This sentence includes two nouns, “ScanSnap” and “software”. The adjective “fast” describes “ScanSnap” and the adverb “very” describes “fast”. The verb “works” refers to “software” and the adverb “efficiently” describes “works”. In this case, two opinion records may be derived from the same sentence.

In some implementations, there are two types of templates and two different ways to extract user opinions. The first is based on shallow structure analysis of a sentence. This does not include syntax analysis, such as using templates based on regular expression to extract opinion records in a sentence. For example, consider the template “$sentence=˜/\b($AttrExp)\s($mod0)\s(($not)\s)?(($intensity)\s)?($OpinionExp)\b/”. This template may be used to match the sentence “The manufacturing quality is so outstanding” according to the following: (1) $mod0=“is|was|are|were|'s|'re|seems|looks|happens to be”; (2) $not is negative indicator; (3) $intensity is intensity indicator; and (4) $OpinionExp is opinion expression.

The second approach is based on dependency templates. It analyzes syntax structure of a sentence for opinion extraction. Some common syntax dependency rules may be extracted to form the templates, and these rules or templates may be applied for opinion extraction. For example, consider the example dependency template illustrated in FIG. 8 as applied to a sentence. There are two cases to extract opinion records from this sentence using the template. In the first case, the expression “fast” is located based on opinion lexicon dictionary. Then, the intensity word “very” is located based on the rule “advmod(JJ,RB)” and the indicator list. “JJ”, which stands for “adjective”, is part of speech (POS) of “fast”, and “RB”, which stands for “adverb”, is POS of “very”. Finally, the object “ScanSnap” is detected based on the rule “nsubj(JJ,NNP)”. Here, no explicit attribute is found, but an implicit attribute should be “speed” (e.g., because of the expression “fast”) defined in the opinion dictionary. In the second case, the expression “efficiently” is located based on opinion lexicon in the dictionary. Then, the verb “works” is located based on the rule “advmod(VB,RB)”, which gives “(works, efficiently)”. “VB” stands for “verb”. Finally, the object “software” is located based on the rule “nsubj(VB,NN)”, which gives “(works, software)”. “NN” stands for “noun”.

In particular embodiments, certain words may be considered as negation indicators or intensity indicators (e.g., adverbs). For example, a sentence may state, “This car is not good.” Even though the word “good” is a positive adjective, the word “not” negates that positive adjective so that the user actually means to say that the car is bad, which is negative. In this case, the words “not” is considered a negation indicator because it negates some other words in the sentence. As another example, a sentence may state, “This car is very good.” In this case, the word “very” further intensifies the word “good”, indicating that the user considers the car extraordinarily good. Another sentence may state, “This car is absolutely terrible.” Here, the word “absolutely” further intensifies the word “terrible”. In these two cases, the words “very” and “absolutely” are considered intensity indicators because they further intensify some other words (e.g., adjectives that may be considered as OpinionExpression) in the sentences.

In some implementations, there may be a predefined list of negation and intensity indicators (214). The words of each sentence may be compared against indicator list (214). If a match is found (i.e., a negation or intensity indicator is found) in the sentence, the OpinionScore may be adjusted accordingly. For example, if a negation indicator is found, a positive OpinionScore may be negated to a corresponding negative value. If an intensity indicator is found, a positive OpinionScore may be suitably further increased or a negative OpinionScore may be suitably further decreased.

In particular embodiments, an object, which is a product or service for which a user opinion is provided, may be extracted from the sentences of the user opinion. Given a specific sentence, the sentence may be parsed to determine if there is any word in the sentence refereeing to a product or service. If so, the word or words are extracted from the sentence as Object for an opinion record. On the other hand, if no such word is found, the previous sentences may be parsed to determine if any word in those previous sentences may refer to a product or service. If so, the word or words are extracted from the sentence as Object for an opinion record. Sometimes, a user may mention a product or service for which he/she provides an opinion in an earlier sentence but does not repeatedly mention the product or service in subsequent sentences. Thus, parsing the previous sentences may help locate the words referring to the product or service even if a specific sentence does not mention the product or service.

To further explain STEPS 202-206, consider the following example sentence: “The engine of my Audi is so powerful.” In this case, the word “engine” is an attribute; the word “Audi” is an object; the word “so” is an intensity indicator; and the word “powerful” is an opinion lexicon. Based on the example attribute illustrated above, when the opinion lexicon “powerful” is associate with the attribute “engine”, the score is “+4”. However, there is an intensity indicator, “so”, found in the sentence. Each intensity indicator can be defined with an intensity score, which can be used to adjust the opinion score of a opinion record based on various methods. Consequently, the score may be increased to “+4.5”. In addition, the user providing the opinion and the time the opinion is given are collected when the opinion is submitted. Thus, the opinion record derived from this sentence may be: (user_{—}1, Audi, engine, powerful, +4.5, 5:00 pm 3/1/2011).

In particular embodiments, the attribute-based opinion records derived from the user opinions may be stored (STEP 207) in a datastore (215) so that they may be readily available for further processing. A user's opinion records on specific products can be group into attribute categories defined in the opinion dictionary, and the user's opinion score of each attribute category can be calculated as average of opinion scores of attributes in this category.

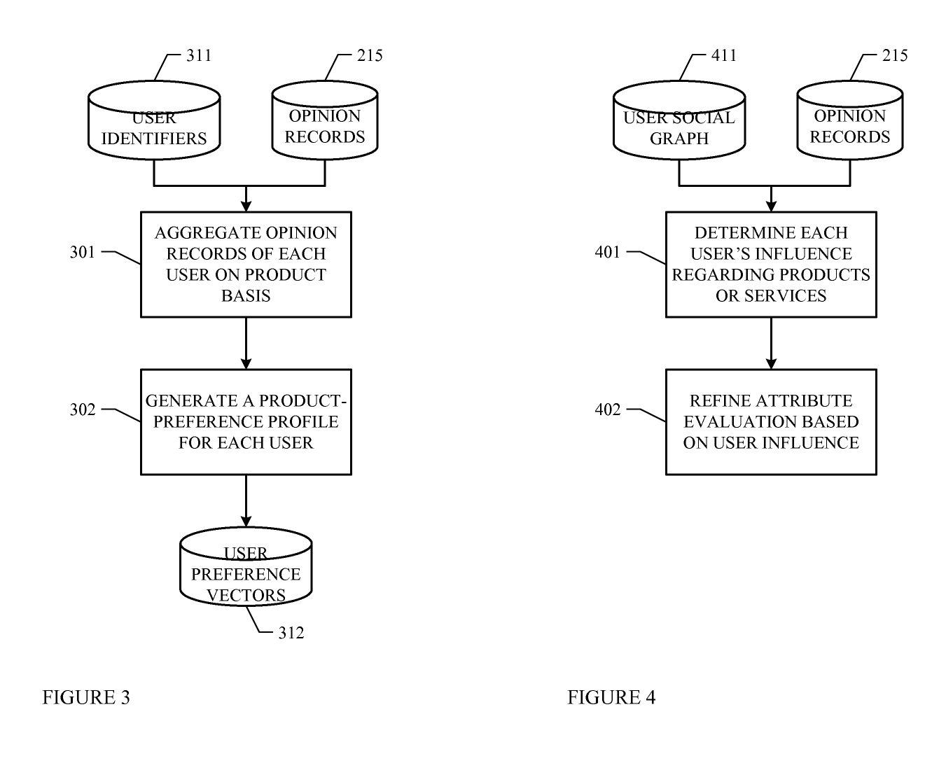

FIG. 3 illustrates an example method for generating product-preference profiles for individual users. Given a set of attribute-based opinion records (215) and a set of users (311) who have provided the user opinions from which attribute-based opinion records (215) are derived, in particular embodiments, the opinion records (215) of each user may be aggregated on product or service basis (STEP 301). Each user may be identified by a unique user identifier (311). A user may provide any number of opinions concerning any number of products or services. A user may provide multiple opinions concerning the same product or service. One or more attribute-based opinion records (214) may be derived from each user opinion text. Thus, each user may be associated with any number of attribute-based opinion records (214) concerning any number of products or services. For those products or services for which a user has provided opinions, the corresponding attribute-based opinion records derived from these opinions are aggregated (STEP 301).

For example, a user providing an opinion concerning an Audi automobile may have discussed the automobile's engine, fuel efficiency, comfort, price, safety, and customer service. Each of these features may have a corresponding attribute-based opinion record. These opinion records may be aggregated together so that all the attributes of the automobile the user has discussed in his/her opinion are taken into consideration.

In particular embodiments, a user preference profile may be generated for each user (STEP 302). One user preference vector may be generated based on the aggregated attribute-based opinion records of the user for specific products or services. Each vector includes the attributes or attribute categories from the aggregated attribute-based opinion records and a preference score for each attribute or attribute category. The score of a attribute or attribute category is determined based on the OpinionScore of the corresponding opinion records of that attribute or attribute category. In particular embodiments, the product-preference profiles of the users, each including a number of user-preference vectors, may be stored in a datastore (312).

In practical applications, user preference vectors are often presented based on attribute categories instead of concrete individual attributes, since it can provide more compact and convenient data view. For example, for the user providing the opinion concerning the automobile, a user-preference vector of six attribute categories generated based on the aggregated opinion records for the automobile may be:

| FEATURE | SCORE |
|---|---|
| driving performance | 5 |
| comfort | 0 |
| safety | 5 |
| price | 2 |
| fuel efficiency | 4 |
| customer service | 5 |

### Example User-Preference Vector

The opinions expressed by a user show that user's interests and concerns on specific products and features. After aggregating all opinions expressed by a user, his/her preferences of specific products or services may be represented as attribute vectors or attribute category vectors. For example, if a user complains about the fuel efficiency of car A, it may be inferred that he prefers high fuel efficiency for cars. If he further expresses that he highly appreciates the customer service of car B, it may be inferred that he is concerned with good customer service for cars. The weight of the vector may be computed based on the user's opinion intensity presented in OpinionScore extracted. The aggregated opinions of a user can come from not only one product, but a class of products. In the above example, the user's preference cars is inferred from both car A and car B.

In particular embodiments, given a specific user X, user X's preferences are inferred based on user X's previous opinion records. In some implementations, if positive values are used for scores of positive opinions and negative values are used for negative opinions, the absolute value of the opinion scores may be used to calculate his preference vector. Because it may be assumed that a user always wants products with good evaluations of all product features or attributes, preference vector should be positive scores. If user X has expressed strong opinions on a specific feature or attribute, it reflects more interests or concerns of the user on this feature or attribute. The absolute values of opinion scores in the opinion records can be used to set values of preference vector. If user X has expressed opinions on the same feature or attribute on more than one product (e.g., user X has expressed opinions on signal reception of cell phone A, cell phone B, cell phone C), the average of the absolute values of scores of this feature or attribute of cell phones A, B and C may be computed for the preference score of this feature. A user's preference score of a specific attribute category can calculated as the average of this user's preference scores of all attributes belonging to the attribute category.

The above approach is one example of preference vector generation. Other inference methods based on opinion records may also be used and this disclosure contemplates any applicable method.

In some implementations, each class of products or services may have a predetermined set of attributes and attribute categories. When a user has provided an opinion concerning specific products or services, a user-preference vector is generated, and the vector includes the predetermined set of attributes or attribute categories. For each attribute or attribute category included in the vector, if there are corresponding attribute-based opinion records of the user concerning the attribute or attribute category, then the score of the attribute or attribute category in the vector is determined based on the OpinionScore of the corresponding attribute-based opinion records. Otherwise (e.g., the user has not discussed a feature in his/her user opinion), the score of the feature in the vector is given a default value (e.g., a medium score). For example, if the range of the score is from −5 to +5, then the default value may be 0.

Humans socialize with each other. Each person has social connections such as families, friends, colleagues, co-workers, acquaintances, etc. When a user provides an opinion concerning a product or service, this opinion may influence others, acquaintances as well as strangers, on how they view that product or service. Such influence may be stronger at certain times and weaker at other times, depending on the user providing the opinion, the others receiving the opinion, or the relationships between the user and the others. For example, if the user providing an opinion concerning a digital camera is an expert in the field (e.g., an engineer developing digital cameras or a photographer who often expresses opinions on digital cameras), that user's opinion may have a stronger influence on others. Among those receiving the user's opinion, the opinion may have a stronger influence on the people who are the user's friends than on the people who are strangers to the user, because the user's friends may trust his/her opinion more.

FIG. 4 illustrates an example method for refining product attribute-based opinion evaluation based on user influence. In particular embodiments, for each user, the user's influence regarding those products or services within a social network is determined (STEP 401). In some implementations, the user's influence may be reflected based on the user's opinion records on a class of product or services (e.g., various types of mobile phones). A social network, in general, is a social structure made up of entities, such as individuals or organizations, that are connected by one or more types of interdependency or relationships, such as friendship, kinship, common interest, financial exchange, dislike, or relationships of beliefs, knowledge, or prestige. In more recent years, social networks have taken advantage of the Internet. There are social-networking systems existing on the Internet in the form of social-networking websites. Such social-networking websites enable their members, who are commonly referred to as website users, to perform various social activities.

The users belonging to a social network and their social connections may be represented by a social graph 411. In some implementations, in user social graph 411, each user may be represented by a node. If there is a social connection between two users, the two corresponding nodes may be linked by an edge. Social graph 411 may be mined to determine each user's influence regarding specific products or services on other users. In some implementations, a user's influence regarding a specific product or service may be determined based on a combination or social graph analysis and the user's opinions on the that product or service.

There are existing methods for social graph analysis or measuring users' influences in a social environment such as twitter and other social media services. PageRank is a link analysis algorithm that assigns a numerical weighting to each node of a hyperlinked set, with the purpose of measuring its relative importance within the set. The algorithm may be applied to any collection of nodes with reciprocal quotations and references. Sometimes, PageRank is applied to social graphs to measure general influence of users, where the rank is measured as \vec{R}=(1−α)M×\vec{R}+α\vec{p} (EQUATION 1). The vector \vec{p} has N elements with the constant value

$$p = 1 / N , and thus \vec{p} = [ 1 / N , … , 1 / N ] .$$

Here, p is a constant probability of randomly jumping from one node to another node. TunkRank is a method for measuring influence on Twitter based on how much attention a user's followers can actually give to the user. Using TunkRank, the influence of a user, X, on his/her followers, Y, may be measured as

$$Influcence ( X ) = {\sum }_{Y ∈ Followers ( X )} \frac{1 + p \times Influence ( Y )}{\vert Following ( Y ) \vert} . \qquad ( EQUATION 2 )$$

Here, p is a constant probability of re-tweeting. Thus, both methods involve a uniform random probability, p, which does not account for various opinion-based interests among the users.

In particular embodiments, a user's influence regarding a product or service is measured by OpinionRank, which enhances PageRank and TunkRank be calculating random probability p for each user according to opinion statistics. So random probability p in each of EQUATION 1 and EQUATION 2 is not fixed but varies from user to user. A user with greater random probability p gets a higher biased influence rank.

Given a specific user, the amount of attention this user can give is spread out among all those other users this user follows. The more other users this user follows, the less attention this user can give each of the other users. A user's influence depends on the amount of attention this user's followers can give this user. Having higher influence depends on having more followers who also have higher influence. In particular embodiments, OpinionRank generates dynamic probability p to replace the fixed value p used in PageRank and TunkRank based on opinion extraction, thus further improving calculation of user influence using EQUATIONS 1 and 2.

To calculate random probability p for each user, in some implementations, if a user ever provides opinions on specific products or services, then that user's weight (i.e., influence measure) for the products or services is 1. Otherwise, that user's weight is 0. The weights of all the users are normalized to determine a random probability p for each user. In other implementations, a different weight may be assigned to each user based on the number of opinion records provided by that user and the specific products or services for which the opinions are provided. Using OpinionRank with dynamic random probability p for each user, the influence of each user's opinions on specific products or services may be computed and measured.

In particular embodiments, the opinion evaluations on attribute or attribute category are refined based on user influence (STEP 402). Given a specific product or service having a number of attributes or attribute categories, a number of users may have provided opinions on this product or service. In the previous opinion analysis systems, the opinion scores of each attribute or each attribute category are calculated by average of opinion scores of all users. Every user is treated evenly. In the approach provided in the present disclosure, for each attribute or attribute category, the opinion scores of all the users who have provided opinions on this product or service may be combined, taking into each user's influence. Thus, given a specific attribute or attribute category of a specific product, its weight or score may be computed as

$$\frac{{\sum }_{i = 1}^{N} ln ( \begin{matrix}OpinionRank ( {user}_{i} ) \times \\ FeatureScore ( {user}_{i} )\end{matrix} )}{{\sum }_{i = 1}^{N} ln ( OpinionRank ( {user}_{i} ) )} ; \qquad ( EQUATION 3 )$$

where N is the total number of users who have provided opinions concerning the specific product, OpinionRank(userᵢ) is the OpinionRank of the i^{th} user, and FeatureScore(userᵢ) is the opinion score of the specific attribute or attribute category from the i^{th} user. A product attribute or attribute category vector of opinion evaluation may then be determined for each specific product, where the weight of each attribute or attribute category in the vector is computed using EQUATION 3.

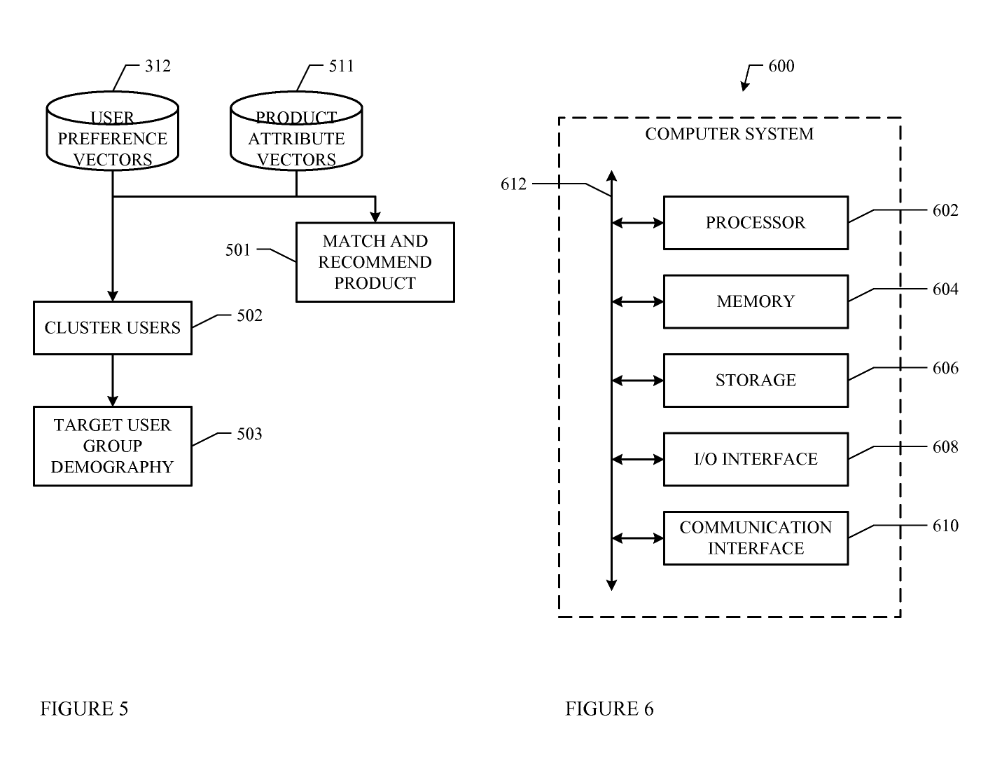

Given a set of users who have provided opinions on various products or services, in particular embodiments, each user has a user-preference profile, which may include a number of user-preference vectors, one corresponding to specific products or services. In addition, each product or service may have a product opinion evaluation score vector. The information may be used for targeted customer relationship management. FIG. 5 illustrates an example method for targeting customer relationship management.

In particular embodiments, given a specific product or service, all users' opinions, may be aggregated so that the opinion score of each attribute or attribute category of the product or service may be generated. The opinion scores of all the attributes or attribute categories of the product or service may be combined into a vector. A product may be matched and recommended to a user based on a comparison of the attribute-based opinion evaluation vector of that product and the user-preference vector of that user (STEP 501). In some implementations, given a specific product and a specific user, the distance between the product attribute vector of the product and the user preference vector of the user may be computed. If the distance is sufficient small (e.g., below a threshold), that product may be recommended to the user.

In particular embodiments, the users may be clustered (STEP 502) based on their respective user preference vectors. In some implementations, given two specific users, the distance between their respective user preference vectors may be computed. If the distance is sufficient small (e.g., below a threshold), the two users may be assigned to the same user group. Otherwise, the two users may be assigned to separate user groups. Target marking may be applied to each group of users with similar product preferences (STEP 503). In addition, the preferences of each group (e.g., with respect to the product features or attributes) may be visually represented (e.g., using a graph).

Particular embodiments may be implemented on one or more computer systems. FIG. 6 illustrates an example computer system 600. In particular embodiments, one or more computer systems 600 perform one or more steps of one or more methods described or illustrated herein. In particular embodiments, one or more computer systems 600 provide functionality described or illustrated herein. In particular embodiments, software running on one or more computer systems 600 performs one or more steps of one or more methods described or illustrated herein or provides functionality described or illustrated herein. Particular embodiments include one or more portions of one or more computer systems 600.

This disclosure contemplates any suitable number of computer systems 600. This disclosure contemplates computer system 600 taking any suitable physical form. As example and not by way of limitation, computer system 600 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, computer system 600 may include one or more computer systems 600; be unitary or distributed; span multiple locations; span multiple machines; or reside in a cloud, which may include one or more cloud components in one or more networks. Where appropriate, one or more computer systems 600 may perform without substantial spatial or temporal limitation one or more steps of one or more methods described or illustrated herein. As an example and not by way of limitation, one or more computer systems 600 may perform in real time or in batch mode one or more steps of one or more methods described or illustrated herein. One or more computer systems 600 may perform at different times or at different locations one or more steps of one or more methods described or illustrated herein, where appropriate.

In particular embodiments, computer system 600 includes a processor 602, memory 604, storage 606, an input/output (I/O) interface 608, a communication interface 610, and a bus 612. Although this disclosure describes and illustrates a particular computer system having a particular number of particular components in a particular arrangement, this disclosure contemplates any suitable computer system having any suitable number of any suitable components in any suitable arrangement.

In particular embodiments, processor 602 includes hardware for executing instructions, such as those making up a computer program. As an example and not by way of limitation, to execute instructions, processor 602 may retrieve (or fetch) the instructions from an internal register, an internal cache, memory 604, or storage 606; decode and execute them; and then write one or more results to an internal register, an internal cache, memory 604, or storage 606. In particular embodiments, processor 602 may include one or more internal caches for data, instructions, or addresses. This disclosure contemplates processor 602 including any suitable number of any suitable internal caches, where appropriate. As an example and not by way of limitation, processor 602 may include one or more instruction caches, one or more data caches, and one or more translation lookaside buffers (TLBs). Instructions in the instruction caches may be copies of instructions in memory 604 or storage 606, and the instruction caches may speed up retrieval of those instructions by processor 602. Data in the data caches may be copies of data in memory 604 or storage 606 for instructions executing at processor 602 to operate on; the results of previous instructions executed at processor 602 for access by subsequent instructions executing at processor 602 or for writing to memory 604 or storage 606; or other suitable data. The data caches may speed up read or write operations by processor 602. The TLBs may speed up virtual-address translation for processor 602. In particular embodiments, processor 602 may include one or more internal registers for data, instructions, or addresses. This disclosure contemplates processor 602 including any suitable number of any suitable internal registers, where appropriate. Where appropriate, processor 602 may include one or more arithmetic logic units (ALUs); be a multi-core processor; or include one or more processors 602. Although this disclosure describes and illustrates a particular processor, this disclosure contemplates any suitable processor.

In particular embodiments, memory 604 includes main memory for storing instructions for processor 602 to execute or data for processor 602 to operate on. As an example and not by way of limitation, computer system 600 may load instructions from storage 606 or another source (such as, for example, another computer system 600) to memory 604. Processor 602 may then load the instructions from memory 604 to an internal register or internal cache. To execute the instructions, processor 602 may retrieve the instructions from the internal register or internal cache and decode them. During or after execution of the instructions, processor 602 may write one or more results (which may be intermediate or final results) to the internal register or internal cache. Processor 602 may then write one or more of those results to memory 604. In particular embodiments, processor 602 executes only instructions in one or more internal registers or internal caches or in memory 604 (as opposed to storage 606 or elsewhere) and operates only on data in one or more internal registers or internal caches or in memory 604 (as opposed to storage 606 or elsewhere). One or more memory buses (which may each include an address bus and a data bus) may couple processor 602 to memory 604. Bus 612 may include one or more memory buses, as described below. In particular embodiments, one or more memory management units (MMUs) reside between processor 602 and memory 604 and facilitate accesses to memory 604 requested by processor 602. In particular embodiments, memory 604 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 604 may include one or more memories 604, where appropriate. Although this disclosure describes and illustrates particular memory, this disclosure contemplates any suitable memory.

In particular embodiments, storage 606 includes mass storage for data or instructions. As an example and not by way of limitation, storage 606 may include an HDD, a floppy disk drive, flash memory, an optical disc, a magneto-optical disc, magnetic tape, or a Universal Serial Bus (USB) drive or a combination of two or more of these. Storage 606 may include removable or non-removable (or fixed) media, where appropriate. Storage 606 may be internal or external to computer system 600, where appropriate. In particular embodiments, storage 606 is non-volatile, solid-state memory. In particular embodiments, storage 606 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 606 taking any suitable physical form. Storage 606 may include one or more storage control units facilitating communication between processor 602 and storage 606, where appropriate. Where appropriate, storage 606 may include one or more storages 606. Although this disclosure describes and illustrates particular storage, this disclosure contemplates any suitable storage.

In particular embodiments, I/O interface 608 includes hardware, software, or both providing one or more interfaces for communication between computer system 600 and one or more I/O devices. Computer system 600 may include one or more of these I/O devices, where appropriate. One or more of these I/O devices may enable communication between a person and computer system 600. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 608 for them. Where appropriate, I/O interface 608 may include one or more device or software drivers enabling processor 602 to drive one or more of these I/O devices. I/O interface 608 may include one or more I/O interfaces 608, where appropriate. Although this disclosure describes and illustrates a particular I/O interface, this disclosure contemplates any suitable I/O interface.

In particular embodiments, communication interface 610 includes hardware, software, or both providing one or more interfaces for communication (such as, for example, packet-based communication) between computer system 600 and one or more other computer systems 600 or one or more networks. As an example and not by way of limitation, communication interface 610 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 610 for it. As an example and not by way of limitation, computer system 600 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 600 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 600 may include any suitable communication interface 610 for any of these networks, where appropriate. Communication interface 610 may include one or more communication interfaces 610, where appropriate. Although this disclosure describes and illustrates a particular communication interface, this disclosure contemplates any suitable communication interface.

In particular embodiments, bus 612 includes hardware, software, or both coupling components of computer system 600 to each other. As an example and not by way of limitation, bus 612 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 612 may include one or more buses 612, where appropriate. Although this disclosure describes and illustrates a particular bus, this disclosure contemplates any suitable bus or interconnect.

Herein, reference to a computer-readable storage medium encompasses one or more non-transitory, tangible computer-readable storage media possessing structure. As an example and not by way of limitation, a computer-readable storage medium may include a semiconductor-based or other integrated circuit (IC) (such, as for example, a field-programmable gate array (FPGA) or an application-specific IC (ASIC)), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. Herein, reference to a computer-readable storage medium excludes any medium that is not eligible for patent protection under 35 U.S.C. §101. Herein, reference to a computer-readable storage medium excludes transitory forms of signal transmission (such as a propagating electrical or electromagnetic signal per se) to the extent that they are not eligible for patent protection under 35 U.S.C. §101. A computer-readable non-transitory storage medium may be volatile, non-volatile, or a combination of volatile and non-volatile, where appropriate.

This disclosure contemplates one or more computer-readable storage media implementing any suitable storage. In particular embodiments, a computer-readable storage medium implements one or more portions of processor 602 (such as, for example, one or more internal registers or caches), one or more portions of memory 604, one or more portions of storage 606, or a combination of these, where appropriate. In particular embodiments, a computer-readable storage medium implements RAM or ROM. In particular embodiments, a computer-readable storage medium implements volatile or persistent memory. In particular embodiments, one or more computer-readable storage media embody software. Herein, reference to software may encompass one or more applications, bytecode, one or more computer programs, one or more executables, one or more instructions, logic, machine code, one or more scripts, or source code, and vice versa, where appropriate. In particular embodiments, software includes one or more application programming interfaces (APIs). This disclosure contemplates any suitable software written or otherwise expressed in any suitable programming language or combination of programming languages. In particular embodiments, software is expressed as source code or object code. In particular embodiments, software is expressed in a higher-level programming language, such as, for example, C, Perl, or a suitable extension thereof. In particular embodiments, software is expressed in a lower-level programming language, such as assembly language (or machine code). In particular embodiments, software is expressed in JAVA, C, or C++. In particular embodiments, software is expressed in Hyper Text Markup Language (HTML), Extensible Markup Language (XML), or other suitable markup language.

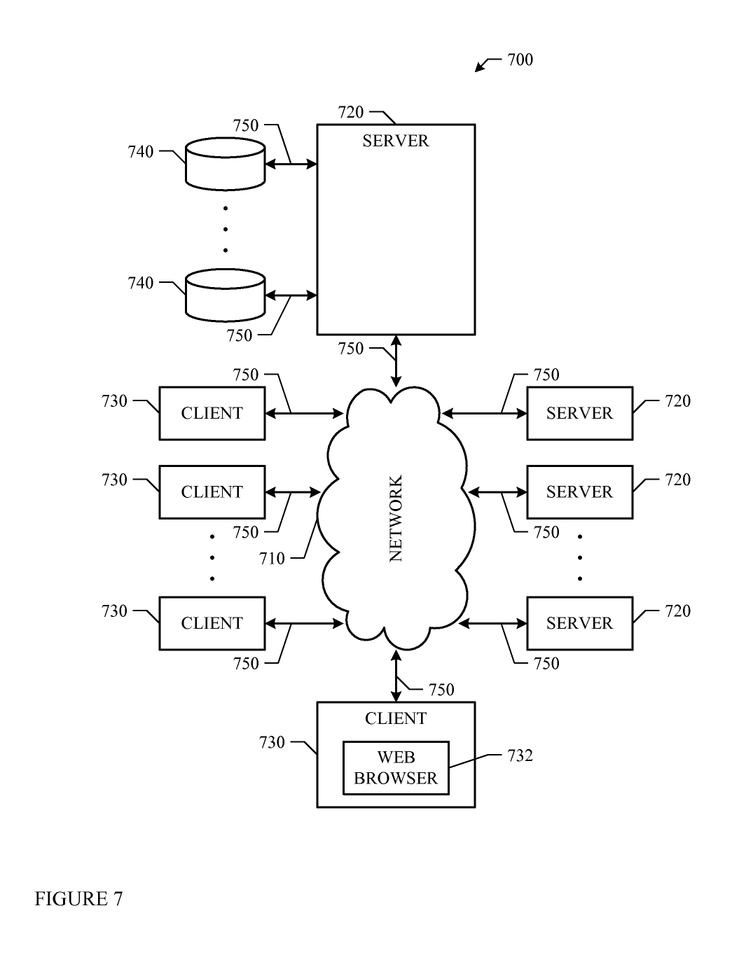

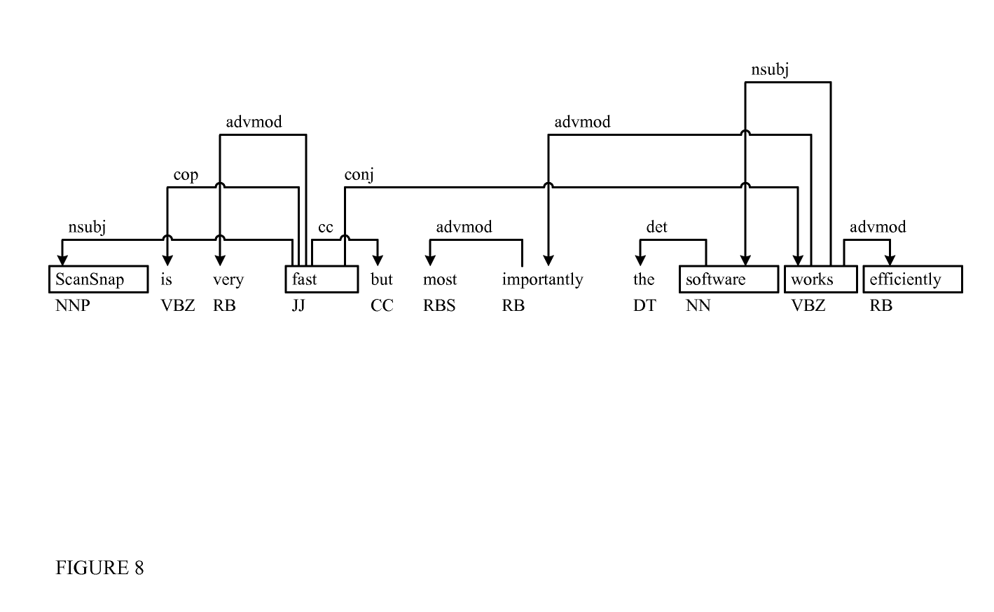

Particular embodiments may be implemented in a network environment. FIG. 7 illustrates an example network environment 700. Network environment 700 includes a network 710 coupling one or more servers 720 and one or more clients 730 to each other. In particular embodiments, network 710 is an intranet, an extranet, a virtual private network (VPN), a local area network (LAN), a wireless LAN (WLAN), a wide area network (WAN), a metropolitan area network (MAN), a portion of the Internet, or another network 710 or a combination of two or more such networks 710. This disclosure contemplates any suitable network 710.

One or more links 750 couple a server 720 or a client 730 to network 710. In particular embodiments, one or more links 750 each includes one or more wireline, wireless, or optical links 750. In particular embodiments, one or more links 750 each includes an intranet, an extranet, a VPN, a LAN, a WLAN, a WAN, a MAN, a portion of the Internet, or another link 750 or a combination of two or more such links 750. This disclosure contemplates any suitable links 750 coupling servers 720 and clients 730 to network 710.

In particular embodiments, each server 720 may be a unitary server or may be a distributed server spanning multiple computers or multiple datacenters. Servers 720 may be of various types, such as, for example and without limitation, web server, news server, mail server, message server, advertising server, file server, application server, exchange server, database server, or proxy server. In particular embodiments, each server 720 may include hardware, software, or embedded logic components or a combination of two or more such components for carrying out the appropriate functionalities implemented or supported by server 720. For example, a web server is generally capable of hosting websites containing web pages or particular elements of web pages. More specifically, a web server may host HTML files or other file types, or may dynamically create or constitute files upon a request, and communicate them to clients 730 in response to HTTP or other requests from clients 730. A mail server is generally capable of providing electronic mail services to various clients 730. A database server is generally capable of providing an interface for managing data stored in one or more data stores.

In particular embodiments, one or more data storages 740 may be communicatively linked to one or more severs 720 via one or more links 750. In particular embodiments, data storages 740 may be used to store various types of information. In particular embodiments, the information stored in data storages 740 may be organized according to specific data structures. In particular embodiments, each data storage 740 may be a relational database. Particular embodiments may provide interfaces that enable servers 720 or clients 730 to manage, e.g., retrieve, modify, add, or delete, the information stored in data storage 740.

In particular embodiments, each client 730 may be an electronic device including hardware, software, or embedded logic components or a combination of two or more such components and capable of carrying out the appropriate functionalities implemented or supported by client 730. For example and without limitation, a client 730 may be a desktop computer system, a notebook computer system, a netbook computer system, a handheld electronic device, or a mobile telephone. This disclosure contemplates any suitable clients 730. A client 730 may enable a network user at client 730 to access network 730. A client 730 may enable its user to communicate with other users at other clients 730.

A client 730 may have a web browser 732, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at client 730 may enter a Uniform Resource Locator (URL) or other address directing the web browser 732 to a server 720, and the web browser 732 may generate a Hyper Text Transfer Protocol (HTTP) request and communicate the HTTP request to server 720. Server 720 may accept the HTTP request and communicate to client 730 one or more Hyper Text Markup Language (HTML) files responsive to the HTTP request. Client 730 may render a web page based on the HTML files from server 720 for presentation to the user. This disclosure contemplates any suitable web page files. As an example and not by way of limitation, web pages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a web page encompasses one or more corresponding web page files (which a browser may use to render the web page) and vice versa, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

What is claimed is:

1. A method comprising: by one or more computing devices,
for each of one or more users, the user having provided one or more opinions concerning one or more products,
deriving one or more opinion records from the one or more opinions, wherein each opinion record is derived from a specific opinion provided by the user concerning a specific product and comprises:
a user identifier of the user;
an object indicating the specific product;
a feature of the specific product;
an opinion expression describing the feature according to the specific opinion provided by the user;
an opinion score of the feature corresponding to the opinion expression; and
a time when the specific opinion is provided by the user; and
generating a user-preference profile based on the one or more opinion records, wherein:
the user-preference profile comprises one or more user-preference vectors corresponding to the one or more products; and
each user-preference vector comprises one or more features of the corresponding product and one or more feature scores respectively corresponding to the one or more features.

2. The method of claim 1, wherein for each user, one or more specific opinion records are derived from a specific opinion provided by the user.

3. The method of claim 2, wherein for each user, deriving the one or more specific opinion records from the specific opinion provided by the user comprises:
separating the specific opinion into one or more sentences; and for each sentence,
determining whether the sentence matches any of a plurality of predefined opinion templates, wherein each opinion template comprises an attribute, an expression describing the attribute, and a score corresponding to the expression;
if the sentence matches a specific predefined opinion template, then constructing a specific opinion record, wherein the feature of the specific opinion record is the attribute of the specific predefined opinion template, the opinion expression of the specific opinion record is the expression of the specific predefined opinion template, and the opinion score of the specific opinion record is the score of the specific predefined opinion template;
determining whether the sentence includes any of a plurality of predefined negation indicators;
if the sentence includes a specific predefined negation indicator, then adjusting the score of the specific opinion record based on the specific predefined negation indicator;
determining whether the sentence includes any of a plurality of predefined intensity indicators; and
if the sentence includes a specific predefined intensity indicator, then adjusting the score of the specific opinion record based on the specific predefined negation indicator.

4. The method of claim 3, wherein for each user, deriving the one or more specific opinion records from the specific opinion provided by the user further comprises:
for each sentence, if the sentence does not match any of the plurality of predefined opinion templates, then:
determining whether the sentence includes any of a plurality of predefined opinion lexicons; and
if the sentence includes a specific predefined opinion lexicon, then constructing the specific opinion record, wherein the opinion expression of the specific opinion record is the specific predefined opinion lexicon.

5. The method of claim 3, wherein for each user, deriving the one or more specific opinion records from the specific opinion provided by the user further comprises:
for each sentence,
determining whether the sentence includes any of the one or more products;
if the sentence includes a specific product, then assigning the object of the specific opinion record to be the specific product; and
if the sentence does not include any of the one or more products, then:
determining whether one or more previous sentences include any of the one or more products; and
if the one or more previous sentences include a specific product, then assigning the object of the specific opinion record to be the specific product.

6. The method of claim 1, wherein for each user, each opinion provided by the user is associated with the user and a time when the opinion is provided.

7. The method of claim 1, further comprising for each user, determining an influence of the user.

8. The method of claim 7, wherein:
the one or more users belong to a social network; and
each user is socially connected to one or more other users within the social network.

9. The method of claim 8, wherein for each user, determining the influence of the user comprises:
computing a random probability for the user based on statistics of the one or more opinions provided by each user; and
computing an opinion rank for the user based on social connections among the one or more users within the social network, influences of each user on other users within the social network, and the random probability of the user.

10. The method of claim 7, further comprising for each of a plurality of products, constructing a product-preference profile based on the user-preference profile of each user, wherein the product-preference profile comprises one or more features of the product, and one feature scores respectively corresponding to the one or more features.

11. The method of claim 10, wherein for each of the plurality of products, constructing the product-preference profile comprises:
for each feature in the product-preference profile, computing the corresponding feature score in the product-preference profile based on one or more specific user-preference vectors corresponding to the product from one or more specific user-preference profiles of one or more specific users, comprising:
for each specific user, adjusting the feature score of the feature in the corresponding specific user-preference vector of the specific user by the influence of the specific user; and
combining one or more adjusted feature stores of the feature associated with the one or more specific users.

12. The method of claim 10, further comprising:
matching one or more of the plurality of products for a first user based on the product-preference profile of each of the one or more of the plurality of products and the user-preference profile of the user; and
recommending the one or more of the plurality of products to the first user.

13. The method of claim 1, further comprising:
clustering the one or more users into one or more user groups based on the user-preference profile of each user; and
target marketing to each user group.

14. The method of claim 1, wherein each product is a physical product, a software product, or a service.

15. A system comprising:
a memory comprising instructions executable by one or more processors; and
the one or more processors coupled to the memory and operable to execute the instructions, the one or more processors being operable when executing the instructions to:
for each of one or more users, the user having provided one or more opinions concerning one or more products,
derive one or more opinion records from the one or more opinions, wherein each opinion record is derived from a specific opinion provided by the user concerning a specific product and comprises:
a user identifier of the user;
an object indicating the specific product;
a feature of the specific product;
an opinion expression describing the feature according to the specific opinion provided by the user;
an opinion score of the feature corresponding to the opinion expression; and
a time when the specific opinion is provided by the user; and
generate a user-preference profile based on the one or more opinion records, wherein:
the user-preference profile comprises one or more user-preference vectors corresponding to the one or more products; and
each user-preference vector comprises one or more features of the corresponding product and one or more feature scores respectively corresponding to the one or more features.

16. The system of claim 15, wherein for each user, one or more specific opinion records are derived from a specific opinion provided by the user.

17. The system of claim 16, wherein for each user, deriving the one or more specific opinion records from the specific opinion provided by the user comprises:
separate the specific opinion into one or more sentences; and
for each sentence,
determine whether the sentence matches any of a plurality of predefined opinion templates, wherein each opinion template comprises an attribute, an expression describing the attribute, and a score corresponding to the expression;
if the sentence matches a specific predefined opinion template, then construct a specific opinion record, wherein the feature of the specific opinion record is the attribute of the specific predefined opinion template, the opinion expression of the specific opinion record is the expression of the specific predefined opinion template, and the opinion score of the specific opinion record is the score of the specific predefined opinion template;
determine whether the sentence includes any of a plurality of predefined negation indicators;
if the sentence includes a specific predefined negation indicator, then adjust the score of the specific opinion record based on the specific predefined negation indicator;
determine whether the sentence includes any of a plurality of predefined intensity indicators; and
if the sentence includes a specific predefined intensity indicator, then adjust the score of the specific opinion record based on the specific predefined negation indicator.

18. The system of claim 17, wherein for each user, deriving the one or more specific opinion records from the specific opinion provided by the user further comprises:
for each sentence, if the sentence does not match any of the plurality of predefined opinion templates, then:
determine whether the sentence includes any of a plurality of predefined opinion lexicons; and
if the sentence includes a specific predefined opinion lexicon, then construct the specific opinion record, wherein the opinion expression of the specific opinion record is the specific predefined opinion lexicon.

19. The system of claim 17, wherein for each user, deriving the one or more specific opinion records from the specific opinion provided by the user further comprises:
for each sentence,
determine whether the sentence includes any of the one or more products;
if the sentence includes a specific product, then assign the object of the specific opinion record to be the specific product; and
if the sentence does not include any of the one or more products, then:
determine whether one or more previous sentences include any of the one or more products; and
if the one or more previous sentences include a specific product, then assign the object of the specific opinion record to be the specific product.

20. The system of claim 15, wherein for each user, each opinion provided by the user is associated with the user and a time when the opinion is provided.

21. The system of claim 15, wherein the one or more processors are further operable when executing the instructions to for each user, determine an influence of the user.

22. The system of claim 21, wherein:
the one or more users belong to a social network; and
each user is socially connected to one or more other users within the social network.

23. The system of claim 22, wherein for each user, determining the influence of the user comprises:
compute a random probability for the user based on statistics of the one or more opinions provided by each user; and
compute an opinion rank for the user based on social connections among the one or more users within the social network, influences of each user on other users within the social network, and the random probability of the user.

24. The system of claim 21, wherein the one or more processors are further operable when executing the instructions to for each of a plurality of products, construct a product-preference profile based on the user-preference profile of each user, wherein the product-preference profile comprises one or more features of the product, and one feature scores respectively corresponding to the one or more features.

25. The system of claim 24, wherein for each of the plurality of products, constructing the product-preference profile comprises:
for each feature in the product-preference profile, compute the corresponding feature score in the product-preference profile based on one or more specific user-preference vectors corresponding to the product from one or more specific user-preference profiles of one or more specific users, comprising:
for each specific user, adjust the feature score of the feature in the corresponding specific user-preference vector of the specific user by the influence of the specific user; and
combine one or more adjusted feature stores of the feature associated with the one or more specific users.

26. The system of claim 24, wherein the one or more processors are further operable when executing the instructions to:
match one or more of the plurality of products for a first user based on the product-preference profile of each of the one or more of the plurality of products and the user-preference profile of the user; and
recommend the one or more of the plurality of products to the first user.

27. The system of claim 15, wherein the one or more processors are further operable when executing the instructions to:
cluster the one or more users into one or more user groups based on the user-preference profile of each user; and
target market to each user group.

28. The system of claim 15, wherein each product is a physical product, a software product, or a service.

29. One or more computer-readable non-transitory storage media embodying software operable when executed by one or more computer systems to:
for each of one or more users, the user having provided one or more opinions concerning one or more products,
derive one or more opinion records from the one or more opinions, wherein each opinion record is derived from a specific opinion provided by the user concerning a specific product and comprises:
a user identifier of the user;
an object indicating the specific product;
a feature of the specific product;
an opinion expression describing the feature according to the specific opinion provided by the user;
an opinion score of the feature corresponding to the opinion expression; and
a time when the specific opinion is provided by the user; and
generate a user-preference profile based on the one or more opinion records, wherein:
the user-preference profile comprises one or more user-preference vectors corresponding to the one or more products; and
each user-preference vector comprises one or more features of the corresponding product and one or more feature scores respectively corresponding to the one or more features.

30. The media of claim 29, wherein for each user, one or more specific opinion records are derived from a specific opinion provided by the user.

31. The media of claim 30, wherein for each user, deriving the one or more specific opinion records from the specific opinion provided by the user comprises:
separate the specific opinion into one or more sentences; and
for each sentence,
determine whether the sentence matches any of a plurality of predefined opinion templates, wherein each opinion template comprises an attribute, an expression describing the attribute, and a score corresponding to the expression;
if the sentence matches a specific predefined opinion template, then construct a specific opinion record, wherein the feature of the specific opinion record is the attribute of the specific predefined opinion template, the opinion expression of the specific opinion record is the expression of the specific predefined opinion template, and the opinion score of the specific opinion record is the score of the specific predefined opinion template;
determine whether the sentence includes any of a plurality of predefined negation indicators;
if the sentence includes a specific predefined negation indicator, then adjust the score of the specific opinion record based on the specific predefined negation indicator;
determine whether the sentence includes any of a plurality of predefined intensity indicators; and
if the sentence includes a specific predefined intensity indicator, then adjust the score of the specific opinion record based on the specific predefined negation indicator.

32. The media of claim 31, wherein for each user, deriving the one or more specific opinion records from the specific opinion provided by the user further comprises:
for each sentence, if the sentence does not match any of the plurality of predefined opinion templates, then:
determine whether the sentence includes any of a plurality of predefined opinion lexicons; and
if the sentence includes a specific predefined opinion lexicon, then construct the specific opinion record, wherein the opinion expression of the specific opinion record is the specific predefined opinion lexicon.

33. The media of claim 31, wherein for each user, deriving the one or more specific opinion records from the specific opinion provided by the user further comprises:
for each sentence,
determine whether the sentence includes any of the one or more products;
if the sentence includes a specific product, then assign the object of the specific opinion record to be the specific product; and
if the sentence does not include any of the one or more products, then:
determine whether one or more previous sentences include any of the one or more products; and
if the one or more previous sentences include a specific product, then assign the object of the specific opinion record to be the specific product.

34. The media of claim 29, wherein for each user, each opinion provided by the user is associated with the user and a time when the opinion is provided.

35. The media of claim 29, wherein the software is further operable when executed by the one or more computer systems to for each user, determine an influence of the user.

36. The media of claim 35, wherein:
the one or more users belong to a social network; and
each user is socially connected to one or more other users within the social network.

37. The media of claim 36, wherein for each user, determining the influence of the user comprises:
compute a random probability for the user based on statistics of the one or more opinions provided by each user; and
compute an opinion rank for the user based on social connections among the one or more users within the social network, influences of each user on other users within the social network, and the random probability of the user.

38. The media of claim 35, wherein the software is further operable when executed by the one or more computer systems to for each of a plurality of products, construct a product-preference profile based on the user-preference profile of each user, wherein the product-preference profile comprises one or more features of the product, and one feature scores respectively corresponding to the one or more features.

39. The media of claim 38, wherein for each of the plurality of products, constructing the product-preference profile comprises:
for each feature in the product-preference profile, compute the corresponding feature score in the product-preference profile based on one or more specific user-preference vectors corresponding to the product from one or more specific user-preference profiles of one or more specific users, comprising:
for each specific user, adjust the feature score of the feature in the corresponding specific user-preference vector of the specific user by the influence of the specific user; and
combine one or more adjusted feature stores of the feature associated with the one or more specific users.

40. The media of claim 38, wherein the software is further operable when executed by the one or more computer systems to:
match one or more of the plurality of products for a first user based on the product-preference profile of each of the one or more of the plurality of products and the user-preference profile of the user; and
recommend the one or more of the plurality of products to the first user.

41. The media of claim 29, wherein the software is further operable when executed by the one or more computer systems to:
cluster the one or more users into one or more user groups based on the user-preference profile of each user; and
target market to each user group.

42. The media of claim 29, wherein each product is a physical product, a software product, or a service.

43. A system comprising:
for each of one or more users, the user having provided one or more opinions concerning one or more products,
means for deriving one or more opinion records from the one or more opinions, wherein each opinion record is derived from a specific opinion provided by the user concerning a specific product and comprises:
a user identifier of the user;
an object indicating the specific product;
a feature of the specific product;
an opinion expression describing the feature according to the specific opinion provided by the user;
an opinion score of the feature corresponding to the opinion expression; and
a time when the specific opinion is provided by the user; and
means for generating a user-preference profile based on the one or more opinion records, wherein:
the user-preference profile comprises one or more user-preference vectors corresponding to the one or more products; and
each user-preference vector comprises one or more features of the corresponding product and one or more feature scores respectively corresponding to the one or more features.
